(19) United States
(12) Patent Application Publication
(10) Pub. No.: US 2026/0353245 A1
(43) Pub. Date: Nov. 5, 2026

(54) METHODS FOR ESTABLISHMENT OF MULTI-PATH COMMUNICATION

(71) Applicant: TOYOTA JIDOSHA KABUSHIKI KAISHA, Toyota-shi, Aichi-ken (JP)

(72) Inventor: Wen-Yao CHANG, New Taipei City (TW)

(73) Assignee: TOYOTA JIDOSHA KABUSHIKI KAISHA, Toyota-shi, Aichi-ken (JP)

(21) Appl. No.: 19/485,982

(22) PCT Filed: May 23, 2024
(86) PCT No.: PCT/JP2024/018997

§ 371 Date: Nov. 19, 2025

Related U.S. Application Data
(60) Provisional application No. 63/504,145, filed on May 24, 2023.

(51) Int. Cl. H04W 40/22; H04W 40/34; H04W 76/14; H04W 88/04

(52) U.S. Cl. CPC H04W 40/22; H04W 40/34; H04W 76/14; H04W 88/04

(57) ABSTRACT

Disclosed are methods, apparatuses, and systems for second path addition in communications. The method includes: triggering, by a base station, a relay of the second path into a state for connecting with the base station; transmitting, to the relay, a first configuration message indicating an addition of the second path, the first configuration message comprising information related to the UE; receiving, from the relay, a first response message indicating a configuration of a relay-to-base-station part of the second path; receiving, from the relay, a notification indicating an establishment of a sidelink communication between the relay and the UE, the notification including a state of the UE; transmitting, to the UE, a second configuration message indicating the addition of the second path; and receiving, from the UE, a second response message indicating a status of configuration of the first path with the addition of the second path.

### CROSS-REFERENCE TO RELATED PATENT APPLICATION

This application is a continuation of PCT/JP2024/018997,filed on May 23, 2024, which claims the benefit of U.S. Provisional Application No. 63/504,145, filed on May 24, 2023, entitled “ESTABLISHMENT OF SIDELINK MULTI-PATH RELAY COMMUNICATION,” the entirety of each of which is incorporated by reference herein.

### FIELD

Apparatuses and methods consistent with the present disclosure relate generally to communications, more specifically, methods, systems, and devices for establishment of multi-path communications.

### BACKGROUND

A multi-path transmission may include a direct communication path between a user equipment (UE) and a network (e. g., a base station), and one or more indirect communication paths between the UE and the network via one or more relays (e. g., UE-to-network relays). The network may adopt muti-path transmission in order to improve reliability and efficiency of the communication with the UE. For example, after establishment of a direct communication path with the UE, the network may decide to add an indirect communication path via a relay, in response to a determination of degradation of communication quality in the direct communication path. To add the indirect communication path, the UE and the relay may need to perform reconfigurations, for example, radio resource control (RRC) reconfigurations. In addition, the UE and relay may need to establish a sidelink connection. But there are challenges in performing such operations by the UE and the relay, for example, due to the requirement of multiple links (paths). For example, the UE may not have access to the RRC state of the relay and the status of the connection between the relay and the network; and the network may not have access to the status of the connection between the UE and the relay. Moreover, the relay is often not in the RRC connected state, although it is generally assumed to be in the RRC connected state. These challenges in indirect path addition may degrade the overall communication quality and efficiency. Systems and methods that allow for reliable and efficient establishment of multi-path transmissions are desired.

### SUMMARY

According to some embodiments of the present disclosure, there is provided a method for adding a second path after a first path between a base station and a UE has been established. The method includes transmitting, to the UE, a first configuration message indicating an addition of the second path, the first configuration message comprising information related to a relay of the second path; transmitting, to the relay, a second configuration message, the second configuration message comprising information related to the UE; receiving, from the relay, a first response message indicating a configuration of a relay-to-base-station part of the second path established based on the second configuration message; and receiving, from the UE, a second response message indicating a status of configuration of the first path with the addition of the second path based on the first configuration message, the second response message including a state of the UE.

According to some embodiments of the present disclosure, there is provided a method for adding a second path after a first path between a base station and a UE has been established. The method includes receiving, from the base station, a configuration message indicating an addition of the second path, the configuration message comprising information related to the UE; transmitting, to the base station, a response message indicating a configuration status of a relay; and transmitting, to the UE, a notification of a status of a relay-to-base-station part of the second path, the notification including a state of the relay.

According to some embodiments of the present disclosure, there is provided a method for adding a second path after a first path between a base station and a UE has been established. The method includes receiving, from the base station, a configuration message indicating an addition of the second path, the configuration message comprising information related to a relay of the second path; establishing a sidelink communication with the relay; and transmitting, to the base station, a response message indicating a status of configuration of the first path with the addition of the second path based on the configuration message.

According to some embodiments of the present disclosure, there is provided a method for adding a second path after a first path between a base station and a UE has been established. The method includes triggering, by the base station, a relay of the second path into a state for connecting with the base station; transmitting, to the relay, a first configuration message indicating an addition of the second path, the first configuration message comprising information related to the UE; receiving, from the relay, a first response message indicating a configuration of a relay-to-base-station part of the second path established based on the first configuration message; receiving, from the relay, a notification indicating an establishment of a sidelink communication between the relay and the UE, the notification including a state of the UE; transmitting, to the UE, a second configuration message indicating the addition of the second path; and receiving, from the UE, a second response message indicating a status of configuration of the first path with the addition of the second path based on the second configuration message.

According to some embodiments of the present disclosure, there is provided a method for adding a second path after a first path between a base station and a UE has been established. The method includes receiving, from the base station, a trigger for triggering a relay to enter a radio resource control (RRC) connected state; receiving, from the base station, a configuration message indicating an addition of the second path, the configuration message comprising information related to the UE; and transmitting, to the base station, a message indicating a configuration of a UE-to-relay part of the second path established based on the configuration message.

According to some embodiments of the present disclosure, there is provided a method for adding a second path after a first path between a base station and a UE has been established. The method includes establishing a sidelink communication with a relay included in a network, the network comprising the base station; receiving, from the network, a configuration message indicating an addition of the second path; and transmitting, to the network, a response message indicating a status of configuration of the first path with the addition of the second path based on the configuration message.

According to some embodiments of the present disclosure, there is provided a base station for adding a second path after a first path between the base station and a UE has been established. The base station includes a memory storing an instruction; and a processor configured to execute the instruction stored in the memory to: transmit, to the UE, a first configuration message indicating an addition of the second path, the first configuration message comprising information related to a relay of the second path; transmit, to the relay, a second configuration message, the second configuration message comprising information related to the UE; receive, from the relay, a first response message indicating a configuration of a relay-to-base-station part of the second path established based on the second configuration message; and receive, from the UE, a second response message indicating a status of configuration of the first path with the addition of the second path based on the first configuration message, the second response message including a state of the UE.

According to some embodiments of the present disclosure, there is provided a relay for adding a second path after a first path between a UE and a base station has been establish. The relay includes a memory storing an instruction; and a processor configured to execute the instruction stored in the memory to: receive, from the base station, a configuration message indicating an addition of the second path, the configuration message comprising information related to the UE; transmit, to the base station, a response message indicating a configuration status of the relay; and transmit, to the UE, a notification of a status of a relay-to-base-station part of the second path, the notification including a state of the relay.

According to some embodiments of the present disclosure, there is provided a UE for adding a second path after a first path between the UE and a base station has been established. The UE includes a memory storing an instruction; and a processor configured to execute the instruction stored in the memory to: receive, from the base station, a configuration message indicating an addition of the second path, the configuration message comprising information related to a relay of the second path; establish a sidelink communication with the relay; and transmit, to the base station, a response message indicating a status of configuration of the first path with the addition of the second path based on the configuration message.

According to some embodiments of the present disclosure, there is provided a base station for adding a second path after a first path between the base station and a UE has been established. The base station includes a

Memory storing an instruction; and a processor configured to execute the instruction stored in the memory to: trigger a relay of the second path into a state for connecting with the base station; transmit, to the relay, a first configuration message indicating an addition of the second path, the first configuration message comprising information related to the UE; receive, from the relay, a first response message indicating a configuration of a relay-to-base-station part of the second path established based on the first configuration message; receive, from the relay, a notification indicating an establishment of a sidelink communication between the relay and the UE, the notification including a state of the UE; transmit, to the UE, a second configuration message indicating the addition of the second path; and receive, from the UE, a second response message indicating a status of configuration of the first path with the addition of the second path based on the second configuration message.

According to some embodiments of the present disclosure, there is provided a relay for adding a second path after a first path between a base station and a UE has been established. The relay includes a memory storing an instruction; and a processor configured to execute the instruction stored in the memory to: receive, from the base station, a trigger for triggering the relay to enter an RRC connected state; receive, from the base station, a configuration message indicating an addition of the second path, the configuration message comprising information related to the UE; and transmit, to the base station, a message indicating a configuration of a UE-to-relay part of the second path established based on the configuration message.

According to some embodiments of the present disclosure, there is provided a UE for adding a second path after a first path between the UE and a base station has been established. The UE includes a memory storing an instruction; and a processor configured to execute the

Instruction stored in the memory to: establish a sidelink communication with a relay included in a network, the network comprising the base station; receive, from the network, a configuration message indicating an addition of the second path; and transmit, to the network, a response message indicating a status of configuration of the first path with the addition of the second path based on the configuration message.

According to some embodiments of the present disclosure, there is provided a non-transitory computer-readable medium storing instructions that are executable by one or more processors of a base station for adding a second path after a first path between the base station and a UE has been established, to perform a method. The method includes transmitting, to the UE, a first configuration message indicating an addition of the second path, the first configuration message comprising information related to a relay of the second path; transmitting, to the relay, a second configuration message, the second configuration message comprising information related to the UE; receiving, from the relay, a first response message indicating a configuration of a relay-to-base-station part of the second path established based on the second configuration message; and receiving, from the UE, a second response message indicating a status of configuration of the first path with the addition of the second path based on the first configuration message, the second response message including a state of the UE.

According to some embodiments of the present disclosure, there is provided a non-transitory computer-readable medium storing instructions that are executable by one or more processors of a relay for adding a second path after a first path between a base station and a UE has been established, to perform a method. The method includes receiving, from the base station, a configuration message indicating an addition of the second path, the configuration message comprising information related to the UE; transmitting, to the base

Station, a response message indicating a configuration status of the relay; and transmitting, to the UE, a notification of a status of a relay-to-base-station part of the second path, the notification including a state of the relay.

According to some embodiments of the present disclosure, there is provided a non-transitory computer-readable medium storing instructions that are executable by one or more processors of a UE for adding a second path after a first path between a base station and the UE has been established, to perform a method. The method includes receiving, from the base station, a configuration message indicating an addition of the second path, the configuration message comprising information related to a relay of the second path; establishing a sidelink communication with the relay; and transmitting, to the base station, a response message indicating a status of configuration of the first path with the addition of the second path based on the configuration message.

According to some embodiments of the present disclosure, there is provided a non-transitory computer-readable medium storing instructions that are executable by one or more processors of a base station for adding a second path after a first path between the base station and a UE has been established, to perform a method. The method includes triggering a relay of the second path into a state for connecting with the base station; transmitting, to the relay, a first configuration message indicating an addition of the second path, the first configuration message comprising information related to the UE; receiving, from the relay, a first response message indicating a configuration of a relay-to-base-station part of the second path established based on the first configuration message; receiving, from the relay, a notification indicating an establishment of a sidelink communication between the relay and the UE, the notification including a state of the UE; transmitting, to the UE, a second configuration message indicating the addition of the second path; and receiving, from the UE, a second response message indicating a status of configuration of the first path with the addition of the second path based on the second configuration message.

According to some embodiments of the present disclosure, there is provided a non-transitory computer-readable medium storing instructions that are executable by one or more processors of a relay for adding a second path after a first path between a base station and a UE has been established, to perform a method. The method includes receiving, from the base station, a trigger for triggering the relay to enter a RRC connected state; receiving, from the base station, a configuration message indicating an addition of the second path, the configuration message comprising information related to the UE; and transmitting, to the base station, a message indicating a configuration of a UE-to-relay part of the second path established based on the configuration message.

According to some embodiments of the present disclosure, there is provided a non-transitory computer-readable medium storing instructions that are executable by one or more processors of a UE for adding a second path after a first path between a base station and a UE has been established, to perform a method. The method includes establishing a sidelink communication with a relay included in a network, the network comprising the base station; receiving, from the network, a configuration message indicating an addition of the second path; and transmitting, to the network, a response message indicating a status of configuration of the first path with the addition of the second path based on the configuration message.

### BRIEF DESCRIPTION OF DRAWINGS

FIG. 1 is a schematic diagram illustrating a multi-path transmission in a communication system, consistent with some embodiments of the present disclosure.

FIG. 2 is a schematic diagram illustrating a procedure for switching from a direct path to an indirect path for a UE in a communication system in the art.

FIG. 3 is a schematic diagram illustrating communication paths for indirect path addition after setup of a direct path between a UE and a network, consistent with some embodiments of the present disclosure.

FIG. 4 is a table illustrating three types of configurations for multi-path transmission establishment, consistent with some embodiments of the present disclosure.

FIG. 5 is a schematic diagram illustrating a procedure for adding an indirect path between a UE and a network in a communication system, consistent with some embodiments of the present disclosure.

FIG. 6 is a schematic diagram illustrating a procedure for adding an indirect path between a UE and a network in a communication system, consistent with some embodiments of the present disclosure.

FIG. 7 is a schematic diagram illustrating a procedure for adding an indirect path between a UE and a network in a communication system, consistent with some embodiments of the present disclosure.

FIG. 8 is a schematic diagram illustrating a procedure for adding an indirect path between a UE and a network in a communication system, consistent with some embodiments of the present disclosure.

FIG. 9 is a schematic diagram illustrating a method for adding a second path after a first path between a base station and a UE has been established, consistent with some embodiments of the present disclosure.

FIG. 10 is a schematic diagram illustrating a method for adding a second path after a first path between a base station and a UE has been established, consistent with some embodiments of the present disclosure.

FIG. 11 is a schematic diagram illustrating a method for adding a second path after a first path between a UE and a base station has been established, consistent with some embodiments of the present disclosure.

FIG. 12 is a schematic diagram illustrating a method for adding a second path after a first path between a base station and a UE has been established, consistent with some embodiments of the present disclosure.

FIG. 13 is a schematic diagram illustrating a method for adding a second path after a first path between a base station and a UE has been established, consistent with some embodiments of the present disclosure.

FIG. 14 is a schematic diagram illustrating a method for adding a second path after a first path between a UE and a base station has been established, consistent with some embodiments of the present disclosure.

FIG. 15 is a block diagram of a device, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

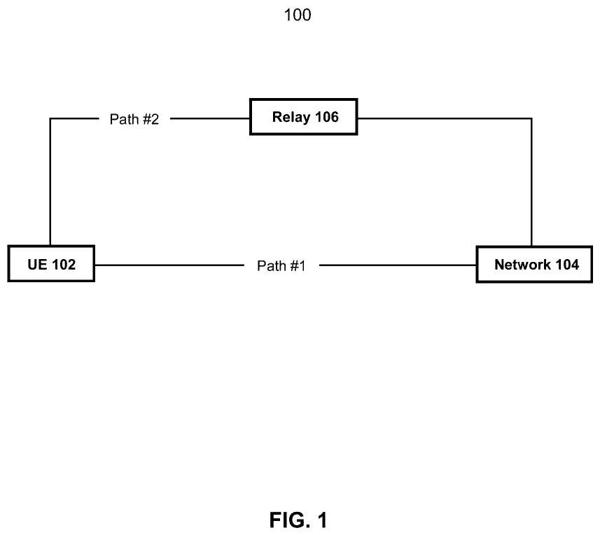

FIG. 1 is a schematic diagram illustrating a multi-path transmission in a communication system, consistent with some embodiments of the present disclosure. Referring to FIG. 1, a communication system 100 includes a UE 102, a network 104, and a relay 106. The UE 102 may be any device, for example, a mobile phone, a wireless handheld device, wireless personal device, a computer, a laptop computer, a vehicle, a component mounted in a vehicle, or any other form. The network 104 may be a base station. The base station can be any base station currently existing, for example, an eNB for long term evolution (LTE) or a gNB for new radio (NR), or a base station for a future generation (6^{th} generation (6G), or any other future generation) radio access technology (RAT). In some embodiments, the relay 106 may be a UE-to-network (U2N) relay. In some embodiments, the relay 106 may be any other UE in the communication system that may have sidelink communication with the UE 102. As shown in FIG. 1, the UE 102 may be connected to the network 104 using a direct communication path (path #1) and an indirect communication path (path #2) via the relay 106 for a multi-path transmission. The use of multi-path transmission may improve reliability and/or data rates for the UE 102. In some embodiments, there can be multiple indirect paths via multiple relays.

Referring to FIG. 1, after the relay 106 is selected based on relay discovery operations, a procedure for establishing a multi-path communication may be initiated. In some embodiments, the indirect communication path (path #2) is added after setup of the direct communication path (path #1). In this case, the UE 102 operating on the direct communication path may add the indirect communication path under the same network 104. In some embodiments, the direct communication path may be added after setup of the indirect communication path. In this case, the UE 102 operating on the indirect communication path may add the direct communication path under the same network 104. In the present disclosure, the terms “direct communication path” and “direct path” are used interchangeably, and the terms “indirect communication path” and “indirect path” are used interchangeably.

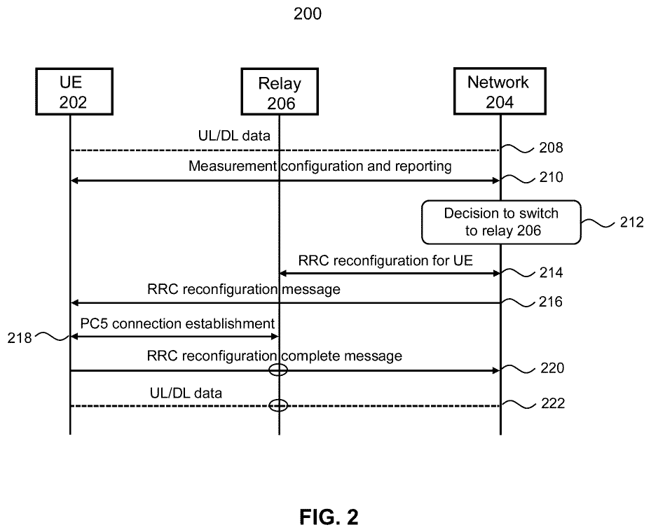

FIG. 2 is a schematic diagram illustrating a procedure for switching from a direct path to an indirect path for a UE in a communication system in the art. Referring to FIG. 2, a communication system 200 includes a UE 202, a network 204, and a relay 206. At a step 208, the UE 202 and the network 204 establish a direct communication. For example, the UE 202 and the network 204 may establish a UE-to-network connection via Uu interface. After the establishment of the direct path, the UE 202 may transmit data to the network 204 via uplink (UL) communication, and the network 204 may transmit data to the UE 202 via downlink (DL) communication. At a step 210, the UE 202 performs measurements and reports the measurements to the network 204. The UE may perform the measurements, for example, based on the settings specified in the measurement configuration provided by the network 204. For example, the UE 202 may measure the signal qualify of the downlink signals and report the measurements to the network 204. In some embodiments, the UE 202 may also report one or more candidate relays to the network 204. At a step 212, the network 204 decides to switch the UE 202 to the relay 206. At a step 214, the network 204 sends an RRC reconfiguration message to the relay 206, and the relay 206 may send a response message to the network 204. At a step 216, the network 204 sends another RRC reconfiguration message to the UE 202 and the UE 202 may send a response message to the network 204. The UE 202 may stop transmissions over the direct path after reception of the RRC reconfiguration message from the network 204. At a step 218, the UE 202 establishes sidelink communication with the relay 206, for example, using PC5 interface. At a step 220, the UE 202 completes the path switch procedure and sends an RRC reconfiguration complete message to the network 204 via the relay 206. At a step 222, the data path is switched from the direct path to the indirect path so that uplink/downlink data between the UE 202 and the network 204 are transmitted via the relay 206.

While the procedure in FIG. 2 can be used for path switching from a direct path to an indirect path, the procedure cannot be used for adding an indirect path after establishment of a direct path, because there are fundamental differences between indirect path addition and switching to an indirect path. For example, the step 212 of the procedure in FIG. 2 may not apply to the procedure for indirect path addition. For indirect path addition, the network 204 may need to make a decision on adding an indirect path, rather than on switching to an indirect path. Further, the steps 214-220 of the procedure in FIG. 2 also may not apply to the procedure for indirect path addition. For indirect path addition, the relay 206 may need to have access to the RRC reconfiguration status for the indirect path, and the UE 202 may need to have access to the RRC reconfiguration status for both the direct and indirect paths. At least some embodiments of the present disclosure address this issue by providing methods and systems for indirect path addition.

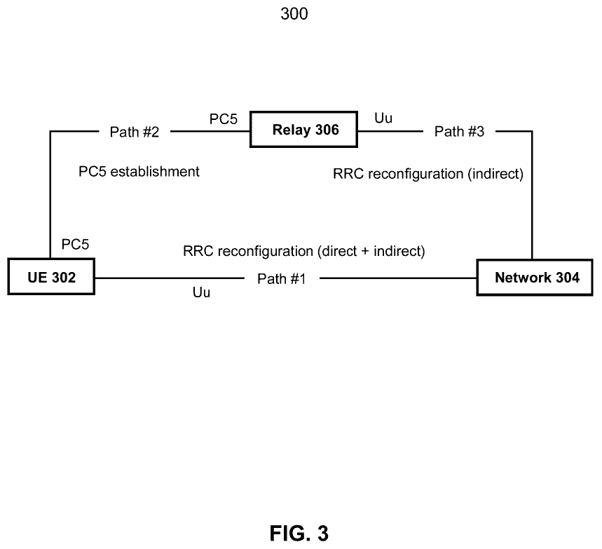

FIG. 3 is a schematic diagram illustrating communication paths for indirect path addition after setup of a direct path between a UE and a network, consistent with some embodiments of the present disclosure. Referring to FIG. 3, a communication system 300 includes a UE 302, a network 304, and a relay 306. The UE 302, the network 304 and the relay 306 may be similar to the UE 102, the network 104 and the relay 106 of FIG. 1, respectively. The UE 302 may be any mobile device, a vehicle, a component mounted in a vehicle, or any other form. The network 304 may be any base station currently existing (e. g., eNB, gNB) or any based station for a future generation. The relay 306 may be a U2N relay or any other UE. In some embodiments, the UE 302 is a vehicle in a vehicle-to-everything (V2X) communication, and the U2N relay is a road side unit. As shown in FIG. 3, the UE 302 may be connected to the network 304 using a direct path (path #1), and an indirect path that includes a path #2 and a path #3 via the relay 306 for a multi-path transmission. In some embodiments, the UE 302 uses multiple indirect paths to communicate with the network 304 via multiple relays.

Referring to FIG. 3, the direct path #1 may use a Uu interface between the UE 302 and the network 304. The indirect path includes two parts (or links): a first part (path #2) between the UE 302 and the relay 306, for example, using PC5 interface, and a second part (path #3) between the relay 306 and the network 304, for example, using Uu interface. After establishment of the direct path (path #1), in order to add the indirect path, the network 304 may send an RRC reconfiguration message to the UE 302 and the RRC reconfiguration message may include the information related to the indirect path addition. Upon reception of the RRC reconfiguration message, the UE 302 may perform the RRC reconfiguration to add the indirect path and send an RRC reconfiguration complete message to the network 304. Similarly, the network 304 may send an RRC reconfiguration message to the relay 306. Upon reception of the RRC reconfiguration message, the relay 306 may perform the RRC reconfiguration to add the indirect path and send an RRC reconfiguration complete message to the network 304. Although FIG. 3 only shows one relay, i.e., the relay 306, as an example candidate relay, the embodiments of the present disclosure are not so limited. In some embodiments, there are multiple candidate relays in the communication system and the network 304 may select one or more relays from the multiple candidate relays. In this case, the UE 302 may communicate with the network 304 using a multi-path transmission including one or more indirect paths via the selected one or more relays.

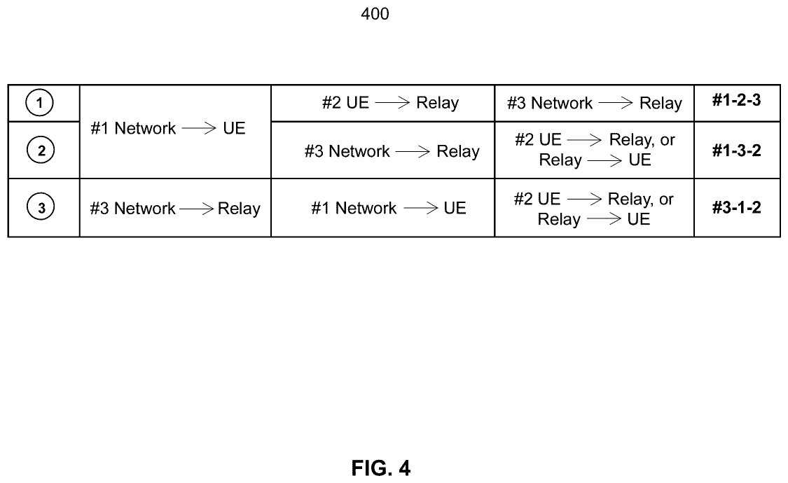

FIG. 4 is a table 400 illustrating three types of configurations for multi-path transmission establishment, consistent with some embodiments of the present disclosure. Referring to FIG. 4, in a first configuration (1), at a first step, a communication path #1 from a network (e.g., the network 304 of FIG. 3) to a UE (e.g., the UE 302 of FIG. 3) is established; at a second step, a communication path #2 from the UE to a relay (e.g., the relay 306 of FIG. 3) is established; and at a third step, a communication path #3 from the network to the relay is established. That is, for the first configuration (1), the communication paths are established by a sequence of path #1-path #2-path #3 (#1-2-3). In a second configuration (2), at a first step, the communication path #1 from the network to the UE is established; at a second step, the communication path #3 from the network to the relay is established; and at a third step, the communication path #2 from the UE to the relay or from the relay to the UE is established. That is, for the second configuration (2), the communication paths are established by a sequence of path #1-path #3-path #2 (#1-3-2). In a third configuration (3), at a first step, a communication path #3 from the network to the relay is established; at a second step, a communication path #1 from the network to the UE is established; and at a third step, a communication path #2 from the UE to relay or from the relay to UE is established. That is, for the third configuration (3), the communication paths are established by a sequence of path #3-path #1-path #2 (#3-1-2).

There are challenges in applying the above-described configurations for a multi-path transmission establishment. For example, the UE may not have access to the RRC state of the relay and the status of the connection between the relay and the network. And the network may not have access to the status of the connection between the UE and the relay. Moreover, the relay may not be in the RRC connected state, although it is generally assumed to be in the RRC connected state in the art.

At least some embodiments of the present disclosure address the above-mentioned challenges and provide methods that allow for an efficient multi-path transmission establishment. For example, at least some embodiments of the present disclosure provide methods in which the RRC state of the relay (e.g., whether the relay is entered in an RRC connected state) is determined for indirect path addition. In some embodiments, the network may notify the UE over the direct path regarding the RRC state of the relay. In some embodiments, the UE may inquire the relay (e. g., over PC5 connection) regarding the RRC state of the relay. In some embodiments, the relay may notify the UE (e.g., over PC5 connection) regarding the RRC state of the relay.

Further, at least some embodiments of the present disclosure provide methods that can flexibly establish communication between the UE and the relay. For example, in some embodiments, the UE initiates the connection between the UE and the relay, while in other embodiments, the relay initiates the connection between the UE and the relay. In some embodiments, the UE reports the status of the UE-relay connection to the network, while in other embodiments, the relay reports the status of the UE-relay connection to the network. Based on the status of the UE-relay connection, the network may configure and cascade the three communication links as shown in FIG. 3 to streamline the indirect path addition, as discussed below.

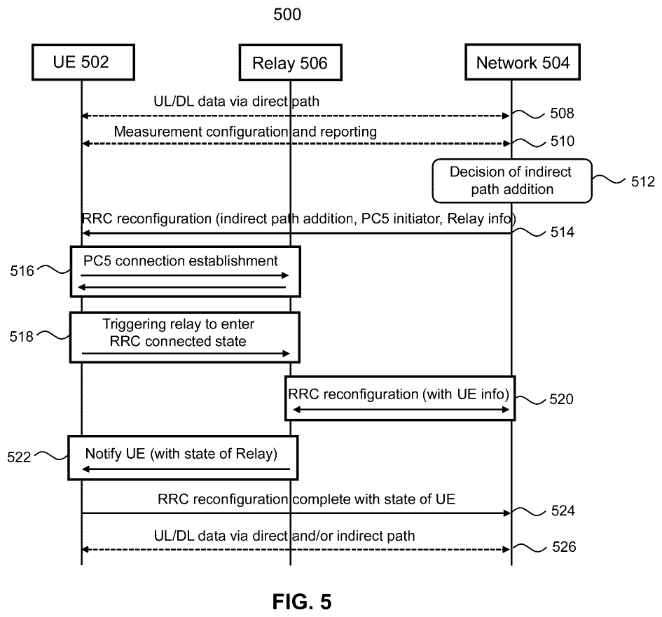

FIG. 5 is a schematic diagram illustrating a procedure for adding an indirect path between a UE and a network in a communication system, consistent with some embodiments of the present disclosure. The procedure of FIG. 5 may correspond to the first configuration (1) of FIG. 4. Referring to FIG. 5, a communication system 500 includes a UE 502, a network 504, and a relay 506. The UE 502, the network 504, and the relay 506 may be similar to the UE 102, the network 104, and the relay 106 of FIG. 1, respectively, or the UE 302, the network 304, and the relay 306 of FIG. 3, respectively. For the sake of brevity, detailed descriptions of the UE 502, the network 504, and the relay 506 are omitted here. As shown in FIG. 5, at a step 508, the UE 502 and the network 504 establish a direct communication. For example, the UE 502 and the network 504 may establish a UE-to-network connection via Uu interface. After establishment of the direct path, the UE 502 may transmit signals/data to the network 504 on uplink communication, and the network 504 may transmit signals/data to the UE 502 on downlink communication.

At a step 510, the UE 502 may perform measurements and report the measurements to the network 504. The UE 502 may perform the measurements, for example, based on the setting specified in the measurement configuration provided by the network 504. For example, the UE 502 may perform measurements on the downlink signals received from the network 504 and report the measured signal qualities to the network 504. In some embodiments, the UE 502 may also report one or more candidate relays to the network 504, after the UE 502 discovers the candidate relays in a discovery process. For example, in some embodiments, the candidate relays are U2N relay UEs and the UE 502 may report to the network 504 at least one of: the relay UE ID, the relay UE's serving cell ID, or sidelink measurements quantity information (e. g., sidelink discovery-reference signal received power (SD-RSRP)). In some embodiments, the UE 502 may selectively report only the candidate relays that fulfil predetermined criteria.

At a step 512, the network 504 decides to add an indirect path between the UE 502 and the network 504 via the relay 506. In some embodiments, the network 504 may decide to add the indirect path based on the measurement report received from the UE 502, for example, based on a determination of degraded communication quality in the direct path. In some embodiments, the network 504 may decide to add the indirect path in order to ensure the reliability of the data transmission, regardless the measurement report received from the UE 502. In some embodiments, the network 504 may decide to add the indirect path based on its own measurements. In some embodiments, instead of the network 504, the UE 502 may decide to add the indirect path and send a request to the network 504. In some embodiments, the network 504 may select the relay 506 as a target relay from among multiple candidate relays based on relay selection criteria at the network.

At a step 514, the network 504 sends an RRC reconfiguration message to the UE 502. The RRC reconfiguration message may include information regarding to the indirect path addition. In some embodiments, the RRC reconfiguration message may also include an initiator for the sidelink connection between the UE 502 and the relay 506. For example, the initiator may be a PC5 initiator as shown in FIG. 5. In some embodiments, the RRC reconfiguration message may also include information regarding the relay 506. The UE 502 may send a response message to the network 504. For example, in some embodiments, the response message may be an acknowledgement of the receipt of the RRC configuration message by the UE 502. In some embodiments, the response message may be an RRC reconfiguration complete message.

At a step 516, in some embodiments, the UE 502 may initiate sidelink connection (e.g., PC5 connection) with the relay 506 based on the information regarding the relay 506 included in the RRC reconfiguration message received from the network 504. Upon establishment of the sidelink connection, the relay has access to information indicating that the UE 502 is ready for the indirect path addition. In some embodiments, instead of the UE 502, the relay 506 may initiate the sidelink connection (e.g., PC5 connection) with the UE 502.

At a step 518, the UE 502 triggers the relay 506 to enter an RRC connected state so that the relay 506 may be ready for RRC reconfiguration with the network 504. This step may be desired when the relay 506 is not in an RRC connected state before the network initiates RRC reconfiguration with the relay 506. In some embodiments, the relay 506 may be in the RRC connected state before the step 514. In this case, the step 518 may not be necessary.

At a step 520, the network 504 sends an RRC reconfiguration message to the relay 506. In some embodiments, the RRC reconfiguration message sent to the relay 506 may include information regarding the UE 502. For example, the network 504 may have the layer-2 identification (ID) information of the UE 502 in advance and include the layer-2 ID information of the UE 502 in the RRC reconfiguration message. After the RRC reconfiguration, the relay 506 may send a response message (e.g., an RRC reconfiguration complete message) to the network 504 so that the network 504 can have information indicating that the relay 506 is ready for the indirect path addition.

At a step 522, the relay 506 sends a notification to the UE 502. In some embodiments, the notification may include the state of the relay 506. For example, the notification may include the RRC reconfiguration state of the relay 506. In this way, by the step 522, the UE 502 can have information indicating that the relay 506 is ready for the indirect path addition.

At a step 524, the UE 502 sends a RRC reconfiguration complete message to the network 504. For example, the RRC reconfiguration message at the step 514 and the RRC reconfiguration complete message at the step 524 may be a pair of messages and the UE 502 may send the RRC reconfiguration complete message as a response to the RRC reconfiguration message received at the step 514. In some embodiments, the RRC reconfiguration complete message may include the state of the UE so that the network 504 can have information indicating that the UE 502 is ready for the indirect path addition. After adding the indirect path via the relay 506, at a step 526, the UE 502 may transmit uplink signals/data to the network 504 via the direct path and/or the indirect path, and the network 504 may transmit downlink signals/data to the UE 502 via the direct path and/or the indirect path.

Although FIG. 5 only shows one relay, i.e., the relay 506, the embodiments of the present disclosure are not so limited. In some embodiments, UE 502 and the network 504 may establish multiple indirect paths via multiple relays.

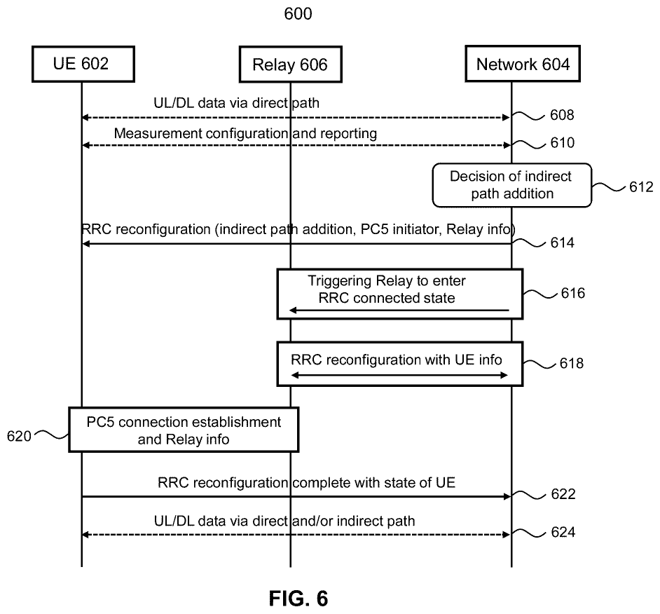

FIG. 6 is a schematic diagram illustrating a procedure for adding an indirect path between a UE and a network in a communication system, consistent with some embodiments of the present disclosure. The procedure of FIG. 6 may correspond to the second configuration (2) of FIG. 4. Referring to FIG. 6, a communication system 600 includes a UE 602, a network 604, and a relay 606. The UE 602, the network 604, and the relay 606 may be similar to the UE 102, the network 104, and the relay 106 of FIG. 1, respectively, or the UE 302, the network 304, and the relay 306 of FIG. 3, respectively. For the Sake of brevity, detailed descriptions of the UE 602, the network 604, and the relay 606 are omitted here. As shown in FIG. 6, at a step 608, the UE 602 and the network 604 establish a direct communication. For example, the UE 602 and the network 604 may establish a UE-to-network connection via Uu interface. The UE 602 may transmit signals/data to the network 604 on uplink communication, and the network 604 may transmit signals/data to the UE 602 on downlink communication.

At a step 610, the UE 602 may perform measurements and report the measurements on the UE-to-network link to the network 604. The UE 602 may perform the measurements, for example, based on the setting specified in the measurement configuration provided by the network 604. For example, the UE 602 may perform measurements on the downlink signals received from the network 604 and report the measured signal qualities to the network 604. In some embodiments, the UE 602 may also report one or more candidate relays to the network 604, after the UE 602 discovers the candidate relays in a discovery process. For example, in some embodiments, the candidate relays are U2N relay UEs and the UE 602 may report to the network 604 at least one of: the relay UE ID, the relay UE's serving cell ID, or sidelink measurements quantity information (e.g., SD-RSRP). In some embodiments, the UE 602 may selectively report candidate relays that fulfil predetermined criteria.

At a step 612, the network 604 decides to add an indirect path between the UE 602 and the network 604 via the relay 606. In some embodiments, the network 604 may decide to add the indirect path based on the measurement report received from the UE 602, for example, based on a determination of degraded communication quality in the direct path. In some embodiments, the network 604 may decide to add the indirect path to ensure the reliability of the data transmission, regardless of the measurement report received from the UE 602. In some embodiments, the network 604 may decide to add the indirect path based on its own measurements. In some embodiments, instead of the network 604, the UE 602 may decide to add the indirect path and send a request to the network 604. In some embodiments, the network 604 may select the relay 606 as a target relay from among multiple candidate relays based on relay selection criteria at the network.

At a step 614, the network 604 sends an RRC reconfiguration message to the UE 602. The RRC reconfiguration message includes information regarding to the indirect path addition. In some embodiments, the RRC reconfiguration message may also include an initiator for the sidelink connection between the UE 602 and the relay 606. For example, the initiator may be a PC5 initiator as shown in FIG. 6. In some embodiments, the RRC reconfiguration message may also include information regarding the relay 606. The UE 602 may send a response message to the network 604. For example, in some embodiments, the response message may be an acknowledgement of the receipt of the RRC configuration message by the UE 602. In some embodiments, the response message may be an RRC reconfiguration complete message.

At a step 616, the network 604 triggers the relay 606 to enter an RRC connected state so that the relay 606 may be ready for RRC reconfiguration with the network 604. This step may be desired when the relay 606 is not in an RRC connected state before the network initiates RRC reconfiguration with the relay 606. In some embodiments, the relay 606 may be in the RRC connected state before the step 614. In this case, the step 616 may not be necessary.

At a step 618, the network 604 sends an RRC reconfiguration message to the relay 606. In some embodiments, the RRC reconfiguration message sent to the relay 606 may include information regarding the UE 602. For example, the network 604 may have the layer-2 ID information of the UE 602 in advance and include the layer-2 ID information of the UE 602 to the RRC reconfiguration message. After the RRC reconfiguration, the relay 606 may send a response message (e. g., an RRC reconfiguration complete message) to the network 604 so that the network 604 can have information indicating that the relay 606 is ready for the indirect path addition.

At a step 620, in some embodiments, the relay 606 may initiate sidelink connection with the UE 602 based on the information regarding the UE 602 included in the RRC reconfiguration message received from the network 604. In some embodiments, the UE 602 may initiate the sidelink connection (e.g., PC5 connection) between with the relay 606. In some embodiments, the initiator (e. g., PC5 initiator) may be determined by the network 604. For example, the network 604 may determine the initiator and send it to the relay 606 by including it in the RRC reconfiguration message sent to the relay 606 in step 618. Alternatively, or in addition, the network 604 may also send the initiator to the UE 602 by including it in the RRC reconfiguration message sent to the UE 602 in step 614. In this way, the UE 602 can have information indicating that the relay 606 is ready for the indirect path addition, and the relay 606 can have information indicating that the UE 602 is ready for the indirect path addition.

At a step 622, the UE 602 sends a RRC reconfiguration complete message to the network 604. For example, the RRC reconfiguration message at the step 614 and the RRC reconfiguration complete message at the step 622 may be a pair of messages and the UE 602 may send the RRC reconfiguration complete message as a response to the RRC reconfiguration message received at the step 614. In some embodiments, the RRC reconfiguration complete message may include the state of the UE so that the network 604 can have information indicating that the UE 602 is ready for the indirect path addition. After adding the indirect path via the relay 606, at a step 624, the UE 602 may transmit uplink signals/data to the network 604 via the direct path and/or the indirect path, and the network 604 may transmit downlink signals/data to the UE 602 via the direct path and/or the indirect path. In some embodiments, UE 602 and the network 604 may establish multiple indirect paths via multiple relays.

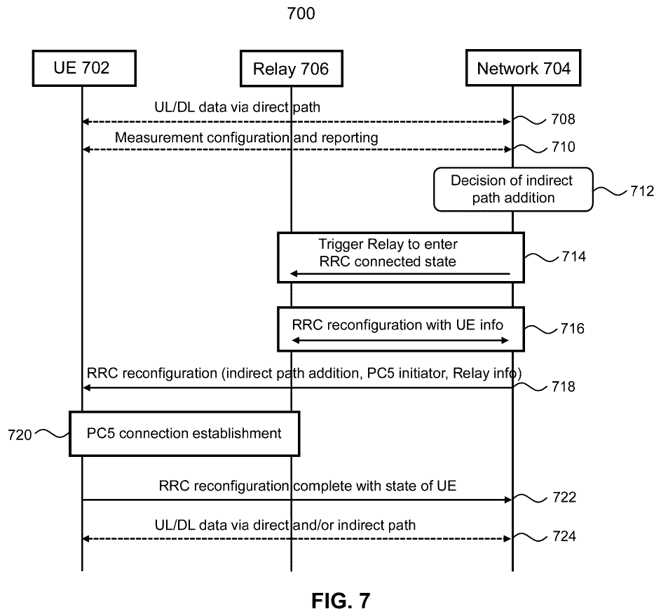

FIG. 7 is a schematic diagram illustrating a procedure for adding an indirect path between a UE and a network in a communication system, consistent with some embodiments of the present disclosure. The procedure of FIG. 7 may correspond to the third configuration (3) of FIG. 4. Referring to FIG. 7, a communication system 700 includes a UE 702, a network 704, and a relay 706. The UE 702, the network 704, and the relay 706 may be similar to the UE 102, the network 104, and the relay 106 of FIG. 1, respectively, or the UE 302, the network 304, and the relay 306 of FIG. 3, respectively. For the sake of brevity, detailed descriptions of the UE 702, the network 704, and the relay 706 are omitted here. As shown in FIG. 7, at a step 708, the UE 702 and the network 704 establish a direct communication. The step 708 is similar to the step 508 of FIG. 5 or the step 608 of FIG. 6. For the sake of brevity, detailed descriptions of the step 708 are omitted here. At a step 710, the UE 702 may perform measurements and report the measurements to the network 704. The UE 702 may perform the measurements, for example, based on the setting specified in the measurement configuration provided by the network 704. The step 710 is similar to the step 510 of FIG. 5 or the step 610 of FIG. 6. For the sake of brevity, detailed descriptions of the step 710 are omitted here.

At a step 712, the network 704 decides to add an indirect path between the UE 702 and the network 704 via the relay 706. The step 712 is similar to the step 512 of FIG. 5 or the step 612 of FIG. 6. For the sake of brevity, detailed descriptions of the step 712 are omitted here. At a step 714, the network 704 triggers the relay 706 to enter an RRC connected state so that the relay 706 may be ready for RRC reconfiguration with the network 704. This step may be desired when the relay 706 is not in an RRC connected state before the step 712. In some embodiments, the relay 706 may be in the RRC connected state before the step 712. In this case, the step 714 may not be necessary.

At a step 716, the network 704 sends an RRC reconfiguration message to the relay 706. In some embodiments, the RRC reconfiguration message sent to the relay 706 may include information regarding the UE 702, for example, the layer-2 ID information of the UE 702. After the RRC reconfiguration, the relay 706 may send a response message (e.g., an RRC reconfiguration complete message) to the network 704 so that the network 704 can have information indicating that the relay 706 is ready for the indirect path addition.

At a step 718, the network 704 sends an RRC reconfiguration message to the UE 702. The RRC reconfiguration message includes information regarding to the indirect path addition. In some embodiments, the RRC reconfiguration message may include information regarding the relay 706. In some embodiments, the RRC reconfiguration message may also include an initiator for the sidelink connection (e.g., PC5 connection) between the UE 702 and the relay 706. For example, the initiator may be a PC5 initiator as shown in FIG. 7. The UE 702 may send a response message to the network 704. For example, in some embodiments, the response message may be an acknowledgement of the receipt of the RRC configuration message by the UE 702. In some embodiments, the response message may be an RRC reconfiguration complete message.

At a step 720, in some embodiments, the UE 702 may initiate sidelink connection (e.g., PC5 connection) with the relay 706 based on the information regarding the relay 706 included in the RRC reconfiguration message received from the network 704. For example, the UE 702 may initiate the sidelink connection based on the PC5 initiator included in the RRC reconfiguration message. In some embodiments, the relay 706 may initiate the sidelink connection with the UE 702. In some embodiments, the initiator (e. g., PC5 initiator) may be determined by the network 704. For example, the network 704 may determine the initiator and send it to UE 702 by including it in the RRC reconfiguration message sent to the UE 702. Alternatively, or in addition, the network 704 may also send the initiator to the relay 706 by including it in the RRC reconfiguration message sent to the relay 706. In this way, the UE 702 can have information indicating that the relay 706 is ready for the indirect path addition, and the relay 706 can have information indicating that the UE 702 is ready for the indirect path addition.

At a step 722, the UE 702 sends a RRC reconfiguration complete message to the network 704. For example, the RRC reconfiguration message at the step 718 and the RRC reconfiguration complete message at the step 722 may be a pair of messages and the UE 702 may send the RRC reconfiguration complete message as a response to the RRC reconfiguration message received at the step 718. In some embodiments, the RRC reconfiguration complete message may include the state of the UE so that the network 704 can have information indicating that the UE 702 is ready for the indirect path addition. After adding the indirect path via the relay 706, at a step 724, the UE 702 may transmit uplink signals/data to the network 704 via the direct path and/or the indirect path, and the network 704 may transmit downlink signals/data to the UE 702 via the direct path and/or the indirect path. In some embodiments, UE 702 and the network 704 may establish multiple indirect paths via multiple relays.

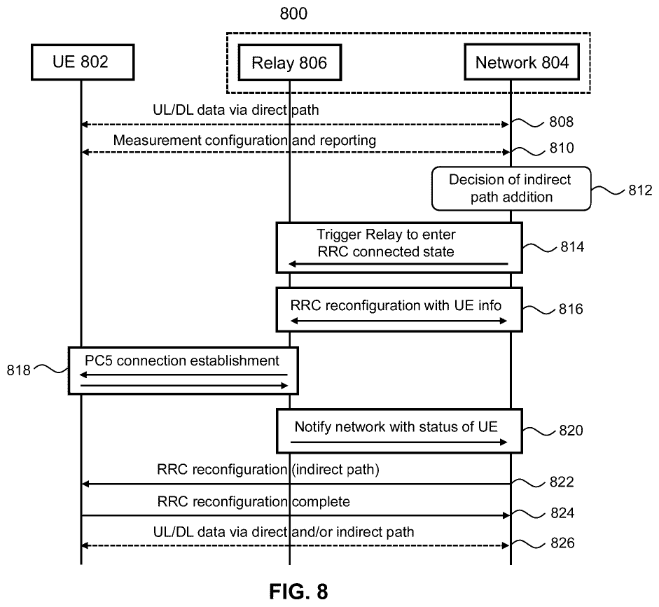

FIG. 8 is a schematic diagram illustrating a procedure for adding an indirect path between a UE and a network in a communication system, consistent with some embodiments of the present disclosure. Referring to FIG. 8, a communication system 800 includes a UE 802, a network 804, and a relay 806. The UE 802, the network 804, and the relay 806 may be similar to the UE 102, the network 104, and the relay 106 of FIG. 1, respectively, or the UE 302, the network 304, and the relay 306 of FIG. 3, respectively. For the sake of brevity, detailed descriptions of the UE 802, the network 804, and the relay 806 are omitted here. Compared with the communication systems of FIGS. 5-7, in FIG. 8, the network 804 and the relay 806 together function as a single (or virtual) network.

At a step 808, the UE 802 and the network 804 establish a direct communication. The step 808 is similar to the step 508 of FIG. 5 or the step 608 of FIG. 6 or the step 708 of FIG. 7. For the sake of brevity, detailed descriptions of the step 808 are omitted here. At a step 810, the UE 802 may perform measurement configuration and report measurements on the UE-to-network link to the network 804. The step 810 is similar to the step 510 of FIG. 5 or the step 610 of FIG. 6 or the step 710 of FIG. 7. For the sake of brevity, detailed descriptions of the step 810 are omitted here.

At a step 812, the network 804 decides to add an indirect path between the UE 802 and the network 804 via the relay 806. The step 812 is similar to the step 512 of FIG. 5 or the step 612 of FIG. 6 or the step 712 of FIG. 7. For the sake of brevity, detailed descriptions of the step 812 are omitted here. At a step 814, the network 804 triggers the relay 806 to enter an RRC connected state so that the relay 806 may be ready for RRC reconfiguration with the network 804. This step may be desired when the relay 806 is not in an RRC connected state before the step 812. In some embodiments, the relay 806 may be in the RRC connected state before the step 812. In this case, the step 814 may not be necessary.

At a step 816, the network 804 sends an RRC reconfiguration message to the relay 806. In some embodiments, the RRC reconfiguration message sent to the relay 806 may include information regarding the UE 802, for example, the layer-2 ID information of the UE 802.

After the RRC reconfiguration, the relay 806 may send a response message (e.g., an RRC reconfiguration complete message) to the network 804 so that the network 804 can have information indicating that the relay 806 is ready for the indirect path addition.

At a step 818, in some embodiments, the relay 806 may initiate sidelink connection (e.g., PC5 connection) with the UE 802 based on the information regarding the UE 802 included in the RRC reconfiguration message received from the network 804. For example, the relay 806 may initiate the PC5 connection based on a PC5 initiator included in the RRC reconfiguration message. In some embodiments, the UE 802 may initiate the sidelink connection with the relay 806. In some embodiments, the initiator (e. g., PC5 initiator) may be determined by the network 804. For example, the network 804 may determine the initiator and send it to the relay 806 by including it in the RRC reconfiguration message sent to the relay 806. In this way, the UE 802 can have information indicating that the relay 806 is ready for the indirect path addition, and the relay 806 can have information indicating that the UE 802 is ready for the indirect path addition.

At a step 820, the relay 806 sends a notification to the network 804. In some embodiments, the notification may include the establishment of the UE-to-relay part of the indirect path. In some embodiments, the notification may include the state of the UE 802. In this way, the network 804 can have information indicating that the UE 802 is ready for the indirect path addition. By sending the notification to the network 804 before the RRC reconfiguration of the UE 802, the procedure involved the UE 802 in a pure passive role, thereby minimizing operation overhead.

At a step 822, the network 804 sends an RRC reconfiguration message to the UE 802. The RRC reconfiguration message includes information regarding to the indirect path addition. At a step 824, the UE 802 sends a RRC reconfiguration complete message to the network 804. After adding the indirect path via the relay 806, at a step 826, the UE 802 may transmit uplink signals/data to the network 804 via the direct path and/or the indirect path, and the network 804 may transmit downlink signals/data to the UE 802 via the direct path and/or the indirect path. In some embodiments, UE 802 and the network 804 may establish multiple indirect paths via multiple relays.

Compared with the three types of configurations as shown in FIG. 4, the procedure in FIG. 8 corresponds to a fourth type of configuration that is different from the configurations in FIG. 4. For example, in the fourth configuration, at a first step, a communication path #3 from the network to the relay is established; at a second step, a communication path #2 from the UE to the relay or from the relay to the UE is established; at a third step, a communication path #1 from the network to the UE is established. That is, for the fourth configuration, the communication paths are established by a sequence of path #3-path #2-path #1 (#3-2-1).

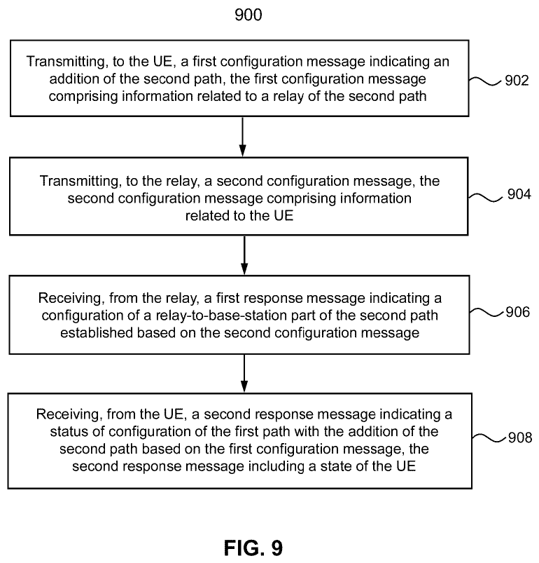

FIG. 9 is a schematic diagram illustrating a method for adding a second path after a first path between a base station and a UE has been established, consistent with some embodiments of the present disclosure. The method may be performed by the base station. The base station can be any base station currently existing (e.g., eNB for LTE or gNB for NR), or a base station for a future generation (6G or any other future generation) RAT. For example, the base station can be the network 504 of FIG. 5, the network 604 of FIG. 6, or the network 704 of FIG. 7. Referring to FIG. 9, a method 900 includes a step 902 of transmitting, to the UE, a first configuration message indicating an addition of the second path, the first configuration message comprising information related to a relay of the second path. The first path may be a direct path between the UE and the base station, and the second path may be an indirect path between the UE and the base station via the relay. The relay may be one or more UEs that are different from the UE, or one or more road side units. In some embodiments, the first configuration message may include an RRC reconfiguration message so that the UE can perform RRC reconfiguration for the indirect path addition. In some embodiments, the first configuration message may also include an initiator for sidelink connection, such as a PC5 initiator. In some embodiments, the information related to the relay included in the first configuration message transmitted to the UE is used by the UE for establishing a sidelink communication between the UE and the relay.

The method 900 includes a step 904 of transmitting, to the relay, a second configuration message, the second configuration message comprising information related to the UE. In some embodiments, the second configuration message may include an RRC reconfiguration message so that the relay can perform RRC reconfiguration for the indirect path addition. In some embodiments, the information related to the UE may be a layer-2 ID information of the UE. In some embodiments, before transmitting the second configuration message to the relay, the method may further include triggering the relay to enter an RRC connected state.

The method 900 includes a step 906 of receiving, from the relay, a first response message indicating a configuration of a relay-to-base-station part of the second path established based on the second configuration message. For example, in some embodiments, the first response message may be an RRC configuration complete message. In some embodiments, the first response message received from the relay may include a status of a UE-to-relay part of the second path.

The method 900 includes a step 908 of receiving, from the UE, a second response message indicating a status of configuration of the first path with the addition of the second path based on the first configuration message, the second response message including a state of the UE. For example, in some embodiments, the second response message may be an RRC configuration complete message.

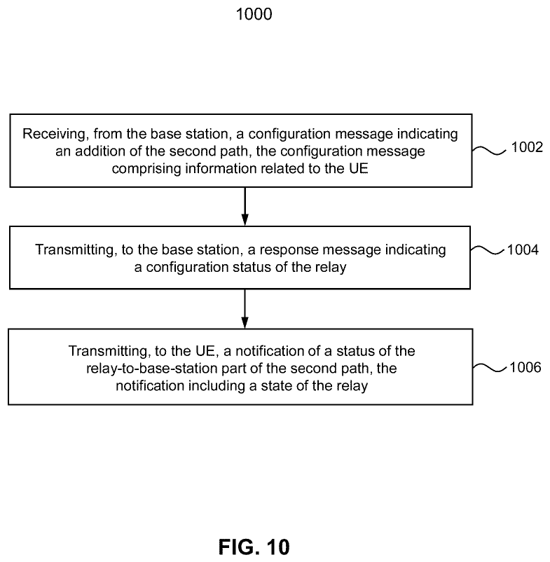

FIG. 10 is a schematic diagram illustrating a method for adding a second path after a first path between a base station and a UE has been established, consistent with some embodiments of the present disclosure. The method may be performed by a relay. The relay may be one or more UEs that are different from the UE, or one or more road side units, such as the relay 506 of FIG. 5. Referring to FIG. 10, a method 1000 includes a step 1002 of receiving, from the base station, a configuration message indicating an addition of the second path, the configuration message comprising information related to the UE. The first path may be a direct path between the UE and the base station, and the second path may be an indirect path between the UE and the base station via the relay. In some embodiments, the configuration message may include an RRC reconfiguration message so that the relay can perform RRC reconfiguration for the indirect path addition.

The method 1000 includes a step 1004 of transmitting, to the base station, a response message indicating a configuration status of the relay. For example, in some embodiments, the response message may be an RRC reconfiguration complete message. In some embodiments, the response message includes a status of configuration of a UE-to-relay part of the second path.

The method 1000 includes a step 1006 of transmitting, to the UE, a notification of a status of the relay-to-base-station part of the second path, the notification including a state of the relay. For example, as shown in FIG. 5, the relay 506 sends to the UE 502 a notification that includes the state of the relay 506.

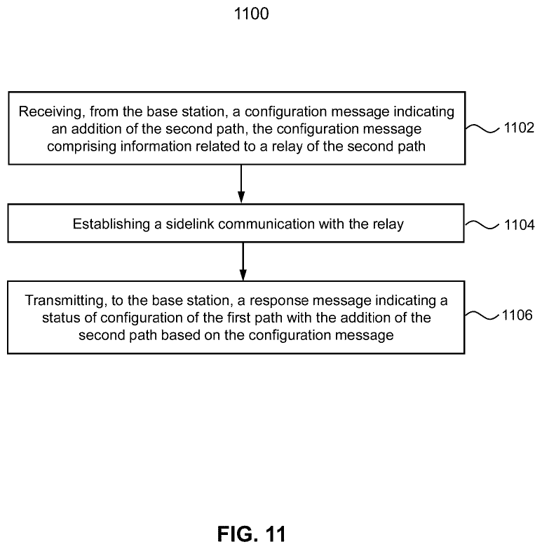

FIG. 11 is a schematic diagram illustrating a method for adding a second path after a first path between a UE and a base station has been established, consistent with some embodiments of the present disclosure. The method may be performed by a UE, such as the UE 502 of FIG. 5, the UE 602 of FIG. 6, or the UE 702 of FIG. 7. Referring to FIG. 11, a method 1100 includes a step 1102 of receiving, from the base station, a configuration message indicating an addition of the second path, the configuration message comprising information related to a relay of the second path. In some embodiments, the configuration message may include an RRC reconfiguration message. In some embodiments, the configuration message may include a PC5 initiator for establishing the sidelink communication. In some embodiments, the PC5 initiator may be determined by the base station.

The method 1100 includes a step 1104 of establishing a sidelink communication with the relay. For example, the UE may establish the sidelink communication based on the PC5 initiator included in the configuration message received from the base station. In some embodiments, the method may further include a step of triggering the relay to enter an RRC connected state after establishment of the sidelink communication. In some embodiments, the method may further include a step of receiving, from the relay, a notification indicating a status of a relay-to-base-station part of the second path, the notification including a state of the relay.

The method 1100 includes a step 1106 of transmitting, to the base station, a response message indicating a status of configuration of the first path with the addition of the second path based on the configuration message. In some embodiments, the response message transmitted to the base station may include a state of the UE.

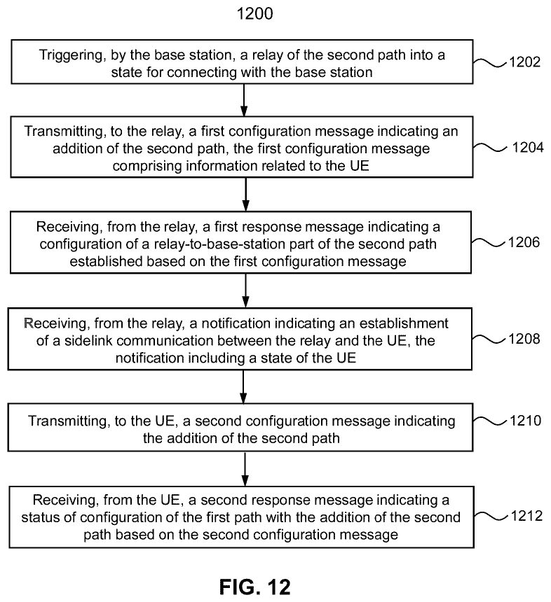

FIG. 12 is a schematic diagram illustrating a method for adding a second path after a first path between a base station and a UE has been established, consistent with some embodiments of the present disclosure. The method may be performed by the base station, such as the network 804 of FIG. 8. Referring to FIG. 12, a method 1200 includes a step 1202 of triggering, by the base station, a relay of the second path into a state for connecting with the base station. In some embodiments, the state for connecting with the base station may be an RRC connected state. The first path may be a direct path between the UE and the base station, and the second path may be an indirect path between the UE and the base station via the relay. In some embodiments, the relay may be one or more UEs that are different from the UE, or one or more road side units.

The method 1200 includes a step 1204 of transmitting, to the relay, a first configuration message indicating an addition of the second path, the first configuration message comprising information related to the UE. In some embodiments, the first configuration message may include a first RRC reconfiguration message. In some embodiments, the combination of the base station and the relay are configured to function as a single network (a virtual network). In some embodiments, the information related to the UE included in the first configuration message may be layer-2 ID information of the UE.

The method 1200 includes a step 1206 of receiving, from the relay, a first response message indicating a configuration of a relay-to-base-station part of the second path established based on the first configuration message. For example, in some embodiments, the first response message may be a reconfiguration complete message.

The method 1200 includes a step 1208 of receiving, from the relay, a notification indicating an establishment of a sidelink communication between the relay and the UE, the notification including a state of the UE. In some embodiments, the sidelink communication between the UE and the relay is established via a PC5 interface. in some embodiments, the PC5 initiator for the sidelink communication is determined by the base station.

The method 1200 includes a step 1210 of transmitting, to the UE, a second configuration message indicating the addition of the second path. In some embodiments, the second configuration message may include a second RRC reconfiguration message.

The method 1200 includes a step 1212 of receiving, from the UE, a second response message indicating a status of configuration of the first path with the addition of the second path based on the second configuration message. In some embodiments, the second response message is an RRC reconfiguration complete message.

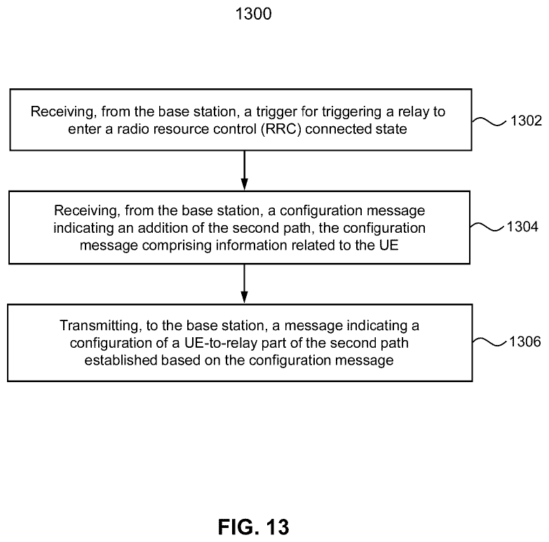

FIG. 13 is a schematic diagram illustrating a method for adding a second path after a first path between a base station and a UE has been established, consistent with some embodiments of the present disclosure. The method may be performed by a relay. The relay may be one or more UEs that are different from the UE, or one or more road side units, such as the relay 606 of FIG. 6, the relay 706 of FIG. 7, or the relay 806 of FIG. 8. Referring to FIG. 13, a method 1300 includes a step 1302 of receiving, from the base station, a trigger for triggering a relay to enter an RRC connected state. The first path may be a direct path between the UE and the base station, and the second path may be an indirect path between the UE and the base station via the relay.

The method 1300 includes a step 1304 of receiving, from the base station, a configuration message indicating an addition of the second path, the configuration message comprising information related to the UE. In some embodiments, the configuration message may include an RRC reconfiguration message. In some embodiments, the information related to the UE may include layer-2 ID information of the UE.

The method 1300 includes a step 1306 of transmitting, to the base station, a message indicating a configuration of a UE-to-relay part of the second path established based on the configuration message. In some embodiments, the message may be a notification transmitted to the base station. In some embodiments, the notification may include a state of the UE, such as, layer-2 ID information of the UE. In some embodiments, the UE-to-relay part of the second path is a sidelink communication established based on a PC5 initiator. In some embodiments, the PC5 initiator is determined by the base station. In some embodiments, the method 1300 may further include a step of establishing a sidelink communication with the UE based on the information related to the UE.

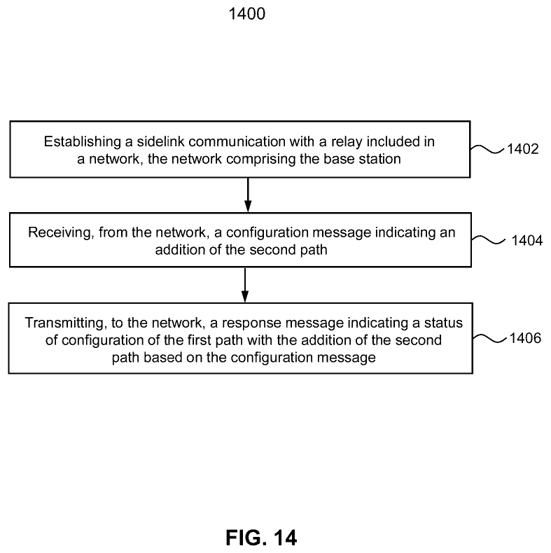

FIG. 14 is a schematic diagram illustrating a method for adding a second path after a first path between a UE and a base station has been established, consistent with some embodiments of the present disclosure. The method may be performed by a UE, such as the UE 802 of FIG. 8. Referring to FIG. 14, a method 1400 includes a step 1402 of establishing a sidelink communication with a relay included in a network, the network comprising the base station. For example, as shown in FIG. 8, the relay 806 and the network 804 together function as a single network. The first path may be a direct path between the UE and the base station, and the second path may be an indirect path between the UE and the base station via the relay. The relay may be one or more UEs that are different from the UE, or one or more road side units. In some embodiments, the sidelink communication may be a sidelink communication between the relay and the UE based on a PC5 initiator. In some embodiments, the PC5initiator may be determined by the base station.

The method 1400 includes a step 1404 of receiving, from the network, a configuration message indicating an addition of the second path. In some embodiments, the configuration message may include an RRC reconfiguration message. In some embodiments, the method 1400 may further include a step of transmitting, to the relay and before receiving the configuration message, a state of the UE.

The method 1400 includes a step 1406 of transmitting, to the network, a response message indicating a status of configuration of the first path with the addition of the second path based on the configuration message. In some embodiments, the response message may include an RRC reconfiguration complete message. In some embodiments, the response message transmitted to the network may include a state of the UE.

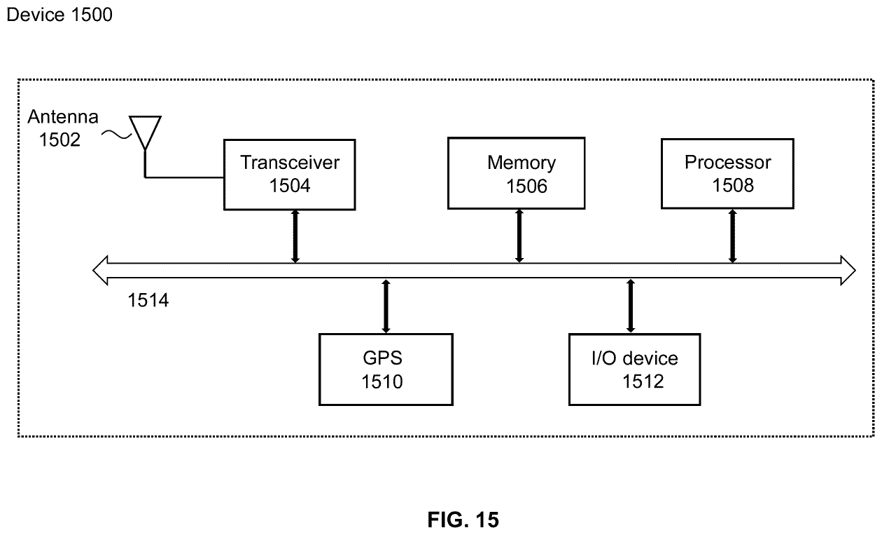

FIG. 15 is a block diagram of a device 1500, consistent with some embodiments of the present disclosure. For example, the device 1500 may be a UE, such as the UE 102 of FIG. 1, the UE 302 of FIG. 3, the UE 502 of FIG. 5, the UE 602 of FIG. 6, the UE 702 of FIG. 7, or the UE 802 of FIG. 8 that establishes a multi-path transmission with a network. Alternatively, the device 1500 may be a relay, such as the relay 106 of FIG. 1, the relay 306 of FIG. 3, the relay 506 of FIG. 5, the relay 606 of FIG. 6, the relay 706 of FIG. 7, or the relay 806 of FIG. 8 that performs relay function for another UE. Alternatively, the device 1500 may be a network, such as the network 104 of FIG. 1, the network 304 of FIG. 3, the network 504 of FIG. 5, the network 604 of FIG. 6, the network 704 of FIG. 7, or the network 804 of FIG. 8 that establishes a multi-path transmission with a UE. The device 1500 may take any form, including but not limited to, a computer system, a vehicle, a component mounted in a vehicle, a road-side unit, a laptop computer, a wireless terminal including a mobile phone, a wireless handheld device, or wireless personal device, or any other form.

Referring to FIG. 15, the device 1500 may include antenna 1502 that may be used for transmission or reception of electromagnetic signals to/from a base station or other UEs. The antenna 1502 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1502 may include multiple (e. g., tens or hundreds) antenna elements and may enable multi-antenna functions such as beamforming. In some embodiments, the antenna 1502 is a single antenna.

The device 1500 may include a transceiver 1504 that is coupled to the antenna 1502. The transceiver 1504 may be a wireless transceiver at the device 1500 and may communicate bi-directionally with a base station or other devices. For example, the transceiver 1504 may receive/transmit wireless signals from/to a base station via downlink/uplink communication. The transceiver 1504 may also receive/transmit wireless signals from/to another device via sidelink communication. The transceiver 1504 may include a modem to modulate the packets and provide the modulated packets to the antenna 1502 for transmission, and to demodulate packets received from the antenna 1502.

The device 1500 may include a memory 1506. The memory 1506 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose special-purpose computer, or a general-purpose or special-purpose processor. In some examples, the software/program code may be transmitted from a remote source (e. g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1506 may store information related to identities of the device 1500 and the signals and/or data received by antenna 1502. The memory 1506 may also store post-processing signals and/or data. The memory 1506 may also store computer-readable program instructions, mathematical models, and algorithms that are used in signal processing in the receiver 1504 and computations in the processor 1508. The memory 1506 may further store computer-readable program instructions for execution by one or more processors to the operate the device 1500 to perform various functions described in this disclosure. In some examples, the memory 1506 may include a basic input/output system (BIOS) which may control basic hardware or software operation such as the interaction with peripheral components or devices.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The device 1500 may include a processor 1508 that may include a hardware device with processing capabilities. The processor 1508 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1508 may be implemented using a combination of devices (e.g., a combination of a DSP and a microprocessor, multiple microprocessors, one or more microprocessors in conjunction with a DSP core, or any other such configuration). The processor 1508 may receive, from the transceiver 1504, downlink signals or sidelink signals and further process the signals. The processor 1508 may also receive, from the transceiver 1504, data packets and further process the packets. In some embodiments, the processor 1508 may be configured to operate a memory using a memory controller. In some embodiments, a memory controller may be integrated into the processor 1508.

The processor 1508 may be configured to execute computer-readable instructions stored in a memory (e.g., the memory 1506) to cause the device 1500 to perform various functions.

The device 1500 may include a global positioning system (GPS) 1510. The GPS 1510 may be used for enabling location-based services or other services based on a geographical position of the device 1500 and/or synchronization among UEs. The GPS 1510 may receive global navigation satellite systems (GNSS) signals from a single satellite or a plurality of satellite signals via the antenna 1502 and provide a geographical position of the device 1500 (e.g., coordinates of the device 1500). In some embodiments, the GPS 1510 is omitted. In some embodiments, a timer is included.

The device 1500 may include an input/output (I/O) device 1512 that may be used to communicate a result of signal processing and computation to a user or another device. The I/O device 1512 may include a user interface including a display and an input device to transmit a user command to the processor 1508. The display may be configured to display a status of signal reception at the device 1500, the data stored at memory 1506, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The device 1500 may further include a machine interface 1514, such as an electrical bus that connects the transceiver 1504, the memory 1506, the processor 1508, the GPS 1510, and the I/O device 1512.

In Some Embodiments, the Device 1500 May Be a Base station for adding a second path after a first path between the base station and a UE has been established. The processor 1508 may be configured or programmed to execute the instructions stored in the memory 1506 to transmit, to the UE, a first configuration message indicating an addition of the second path, the first configuration message comprising information related to a relay of the second path; transmit, to the relay, a second configuration message, the second configuration message comprising information related to the UE; receive, from the relay, a first response message indicating a configuration of a relay-to-base-station part of the second path established based on the second configuration message; and receive, from the UE, a second response message indicating a status of configuration of the first path with the addition of the second path based on the first configuration message, the second response message including a state of the UE.

In some embodiments, the device 1500 may be a relay for adding a second path after a first path between a UE and a base station has been established. The processor 1508 may be configured or programmed to execute the instructions stored in the memory 1506 to receive, from the base station, a configuration message indicating an addition of the second path, the configuration message comprising information related to the UE; transmit, to the base station, a response message indicating a configuration of the relay; and transmit, to the UE, a notification of a status of the relay-to-base-station part of the second path, the notification including a state of the relay.

In some embodiments, the device 1500 may be a UE for adding a second path after a first path between the UE and a base station has been established. The processor 1508 may be configured or programmed to execute the instructions stored in the memory 1506 to receive, from the base station, a configuration message indicating an addition of the second path, the configuration message comprising information related to a relay of the second path; establish a sidelink communication with the relay; and transmit, to the base station, a response message indicating a status of configuration of the first path with the addition of the second path based on the configuration message.

In some embodiments, the device 1500 may be a base station for adding a second path after a first path between the base station and a UE has been established. The processor 1508 may be configured or programmed to execute the instructions stored in the memory 1506 to trigger a relay of the second path into a state for connecting with the base station; transmit, to the relay, a first configuration message indicating an addition of the second path, the first configuration message comprising information related to the UE; receive, from the relay, a first response message indicating a configuration of a relay-to-base-station part of the second path established based on the first configuration message; receive, from the relay, a notification indicating an establishment of a sidelink communication between the relay and the UE, the notification including a state of the UE; transmit, to the UE, a second configuration message indicating the addition of the second path; and receive, from the UE, a second response message indicating a status of configuration of the first path with the addition of the second path based on the second configuration message.

In some embodiments, the device 1500 may be a relay for adding a second path after a first path between a UE and a base station has been established. The processor 1508 may be configured or programmed to execute the instructions stored in the memory 1506 to receive, from the base station, a trigger for triggering the relay to enter an RRC connected state; receive, from the base station, a configuration message indicating an addition of the second path, the configuration message comprising information related to the UE; and transmit, to the base station, a message indicating a configuration of a UE-to-relay part of the second path established based on the configuration message.

In some embodiments, the device 1500 may be a UE for adding a second path after a first path between the UE and a base station has been established. The processor 1508 may be configured or programmed to execute the instructions stored in the memory 1506 to establish a sidelink communication with a relay included in a network, the network comprising the base station; receive, from the network, a configuration message indicating an addition of the second path; and transmit, to the network, a response message indicating a status of configuration of the first path with the addition of the second path based on the configuration message.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1: A method for adding a second path after a first path between a base station and a user equipment (UE) has been established, the method comprising:
transmitting, to the UE, a first configuration message indicating an addition of the second path, the first configuration message comprising information related to a relay of the second path;
transmitting, to the relay, a second configuration message, the second configuration message comprising information related to the UE;
receiving, from the relay, a first response message indicating a configuration of a relay-to-base-station part of the second path established based on the second configuration message; and
receiving, from the UE, a second response message indicating a status of configuration of the first path with the addition of the second path based on the first configuration message, the second response message including a state of the UE.

Clause 2: The method of clause 1, wherein the first path is a direct path between the UE and the base station, and the second path is an indirect path between the UE and the base station via the relay.

Clause 3: The method of clause 1, wherein the relay comprises at least one of: one or more UEs that are different from the UE, or one or more road side units.

Clause 4: The method of clause 1, wherein the first configuration message comprises a radio resource control (RRC) reconfiguration message.

Clause 5: The method of clause 4, wherein the first configuration message comprises a PC5 initiator.

Clause 6: The method of clause 1, wherein the second configuration message comprises an RRC reconfiguration message.

Clause 7: The method of clause 1, wherein the information related to the relay included in the first configuration message transmitted to the UE is used by the UE for establishing a sidelink communication between the UE and the relay.

Clause 8: The method of clause 1, wherein the first response message received from the relay comprises a status of a UE-to-relay part of the second path.

Clause 9: The method of clause 1, wherein before transmitting the second configuration message to the relay, the method further comprises:

triggering the relay to enter an RRC connected state.

Clause 10: A method for adding a second path after a first path between a base station and a user equipment (UE) has been established, the method comprising:
receiving, from the base station, a configuration message indicating an addition of the second path, the configuration message comprising information related to the UE;
transmitting, to the base station, a response message indicating a configuration status of a relay; and
transmitting, to the UE, a notification of a status of a relay-to-base-station part of the second path, the notification including a state of the relay.

Clause 11: The method of clause 10, wherein the first path is a direct path between the UE and the base station, and the second path is an indirect path between the UE and the base station via the relay.

Clause 12: The method of clause 10, wherein the relay comprises at least one of: one or more UEs that are different from the UE, or one or more road side units.

Clause 13: The method of clause 10, wherein the configuration message comprises a radio resource control (RRC) reconfiguration message.

Clause 14: The method of clause 10, wherein the response message transmitted to the base station comprises a status of configuration of a UE-to-relay part of the second path.

Clause 15: A method for adding a second path after a first path between a user equipment (UE) and a base station has been established, the method comprising:
receiving, from the base station, a configuration message indicating an addition of the second path, the configuration message comprising information related to a relay of the second path;
establishing a sidelink communication with the relay; and
transmitting, to the base station, a response message indicating a status of configuration of the first path with the addition of the second path based on the configuration message.

Clause 16: The method of clause 15, wherein the configuration message comprises a radio resource control (RRC) reconfiguration message.

Clause 17: The method of clause 15, wherein the configuration message comprises a PC5 initiator for establishing the sidelink communication.

Clause 18: The method of clause 17, wherein the PC5 initiator is determined by the base station.

Clause 19: The method of clause 15, wherein the method further comprises:
triggering the relay to enter a radio resource control (RRC) connected state after establishment of the sidelink communication.

Clause 20: The method of clause 15, wherein the method further comprises:
receiving, from the relay, a notification indicating a status of a relay-to-base-station part of the second path, the notification including a state of the relay.

Clause 21: The method of clause 15, wherein the response message transmitted to the base station comprises a state of the UE.

Clause 22: A method for adding a second path after a first path between a base station and a user equipment (UE) has been established, the method comprising:
triggering, by the base station, a relay of the second path into a state for connecting with the base station;
transmitting, to the relay, a first configuration message indicating an addition of the second path, the first configuration message comprising information related to the UE;
receiving, from the relay, a first response message indicating a configuration of a relay-to-base-station part of the second path established based on the first configuration message;
receiving, from the relay, a notification indicating an establishment of a sidelink communication between the relay and the UE, the notification including a state of the UE;
transmitting, to the UE, a second configuration message indicating the addition of the second path; and
receiving, from the UE, a second response message indicating a status of configuration of the first path with the addition of the second path based on the second configuration message.

Clause 23: The method of clause 22, wherein the first path is a direct path between the UE and the base station, and the second path is an indirect path between the UE and the base station via the relay.

Clause 24: The method of clause 22, wherein the relay comprises at least one of: one or more UEs that are different from the UE, or one or more road side units.

Clause 25: The method of clause 22, wherein the first configuration message comprises a first radio resource control (RRC) reconfiguration message and the second configuration message comprises a second RRC reconfiguration message.

Clause 26: The method of clause 22, wherein a combination of the base station and the relay are configured to function as a network.

Clause 27: The method of clause 22, wherein the state for connecting with the base station is an RRC connected state.

Clause 28: The method of clause 22, wherein the sidelink communication between the UE and the relay is established via a PC5 interface.

Clause 29: The method of clause 22, wherein the information related to the UE included in the first configuration message comprises a layer-2 identification (ID) of the UE.

Clause 30: A method for adding a second path after a first path between a base station and a user equipment (UE) has been established, the method comprising:
receiving, from the base station, a trigger for triggering a relay to enter a radio resource control (RRC) connected state;
receiving, from the base station, a configuration message indicating an addition of the second path, the configuration message comprising information related to the UE; and
transmitting, to the base station, a message indicating a configuration of a UE-to-relay part of the second path established based on the configuration message.

Clause 31: The method of clause 30, wherein the message is a notification transmitted to the base station and the notification includes a state of the UE.

Clause 32: The method of clause 30, wherein the first path is a direct path between the UE and the base station, and the second path is an indirect path between the UE and the base station via the relay.

Clause 33: The method of clause 30, wherein the relay Comprises at least one of: one or more UEs that are different from the UE, or one or more road side units.

Clause 34: The method of clause 30, wherein the configuration message comprises a RRC reconfiguration message. relay part of the second path is a sidelink communication established via a PC5 initiator.

Clause 36: The method of clause 35, wherein the PC5 initiator is determined by the base station.

Clause 37: The method of clause 30, further comprises:
establishing a sidelink communication with the UE based on the information related to the UE.

Clause 38: A method for adding a second path after a first path between a user equipment (UE) and a base station has been established, the method comprising:
establishing a sidelink communication with a relay included in a network, the network comprising the base station;
receiving, from the network, a configuration message indicating an addition of the second path; and
transmitting, to the network, a response message indicating a status of configuration of the first path with the addition of the second path based on the configuration message.

Clause 39: The method of clause 38, wherein the first path is a direct path between the UE and the base station, and the second path is an indirect path between the UE and the base station via the relay.

Clause 40: The method of clause 38, wherein the relay comprises at least one of: one or more UEs that are different from the UE, or one or more road side units.

Clause 41: The method of clause 38, wherein the configuration message comprises a radio resource control (RRC) reconfiguration message.

Clause 42: The method of clause 38, wherein the sidelink communication is a sidelink communication between the relay and the UE via a PC5 initiator.

Clause 43: The method of clause 42, wherein the PC5 initiator is determined by the base station.

Clause 44: The method of clause 38, wherein the response message comprises an RRC reconfiguration complete message.

Clause 45: The method of clause 38, wherein the method further comprises:
transmitting, to the relay and before receiving the configuration message, a state of the UE.

Clause 46: A base station for adding a second path after a first path between the base station and a user equipment (UE) has been established, the base station comprising:
a memory storing an instruction; and
a processor configured to execute the instruction stored in the memory to:
   transmit, to the UE, a first configuration message indicating an addition of the second path, the first configuration message comprising information related to a relay of the second path;
   transmit, to the relay, a second configuration message, the second configuration message comprising information related to the UE;
   receive, from the relay, a first response message indicating a configuration of a relay-to-base-station part of the second path established based on the second configuration message; and
   receive, from the UE, a second response message indicating a status of configuration of the first path with the addition of the second path based on the first configuration message, the second response message including a state of the UE.

Clause 47: A relay for adding a second path after a first path between a user equipment (UE) and a base station has been established, the relay comprising:
a memory storing an instruction; and
a processor configured to execute the instruction stored in the memory to:
   receive, from the base station, a configuration message indicating an addition of the second path, the configuration message comprising information related to the UE;
   transmit, to the base station, a response message indicating a configuration status of the relay; and
   transmit, to the UE, a notification of a status of a relay-to-base-station part of the second path, the notification including a state of the relay.

Clause 48: A user equipment (UE) for adding a second path after a first path between the UE and a base station has been established, the UE comprising:
a memory storing an instruction; and
a processor configured to execute the instruction stored in the memory to:
   receive, from the base station, a configuration message indicating an addition of the second path, the configuration message comprising information related to a relay of the second path;
   establish a sidelink communication with the relay; and
   transmit, to the base station, a response message indicating a status of configuration of the first path with the addition of the second path based on the configuration message.

Clause 49: A base station for adding a second path after a first path between the base station and a user equipment (UE) has been established, the base station comprising:
a memory storing an instruction; and
a processor configured to execute the instruction stored in the memory to:
   trigger a relay of the second path into a state for connecting with the base station;
   transmit, to the relay, a first configuration message indicating an addition of the second path, the first configuration message comprising information related to the UE;
   receive, from the relay, a first response message indicating a configuration of a relay-to-base-station part of the second path established based on the first configuration message;
   receive, from the relay, a notification indicating an establishment of a sidelink communication between the relay and the UE, the notification including a state of the UE;
   transmit, to the UE, a second configuration message indicating the addition of the second path; and
   receive, from the UE, a second response message indicating a status of configuration of the first path with the addition of the second path based on the second configuration message.

Clause 50: A relay for adding a second path after a first path between a base station and a user equipment (UE) has been established, the relay comprising:
a memory storing an instruction; and
a processor configured to execute the instruction stored in the memory to:
   receive, from the base station, a trigger for triggering the relay to enter a radio resource control (RRC) connected state;
   receive, from the base station, a configuration message indicating an addition of the second path, the configuration message comprising information related to the UE; and
   transmit, to the base station, a message indicating a configuration of a UE-to-relay part of the second path established based on the configuration message.

Clause 51: A user equipment (UE) for adding a second path after a first path between the UE and a base station has been established, the UE comprising:
a memory storing an instruction; and
a processor configured to execute the instruction stored in the memory to:
   establish a sidelink communication with a relay included in a network, the network comprising the base station;
   receive, from the network, a configuration message indicating an addition the second path; and
   transmit, to the network, a response message indicating a status of configuration of the first path with the addition of the second path based on the configuration message.

Clause 52: A non-transitory computer-readable medium storing instructions that are executable by one or more processors of a base station for adding a second path after a first path between the base station and a user equipment (UE) has been established, to perform a method, the method comprising:
transmitting, to the UE, a first configuration message indicating an addition of the second path, the first configuration message comprising information related to a relay of the second path;
transmitting, to the relay, a second configuration message, the second configuration message comprising information related to the UE;
receiving, from the relay, a first response message indicating a configuration of a relay-to-base-station part of the second path established based on the second configuration message; and
receiving, from the UE, a second response message indicating a status of configuration of the first path with the addition of the second path based on the first configuration message, the second response message including a state of the UE.

Clause 53: A non-transitory computer-readable medium storing instructions that are executable by one or more processors of a relay for adding a second path after a first path between a base station and a user equipment (UE) has been established, to perform a method, the method comprising:
receiving, from the base station, a configuration message indicating an addition of the second path, the configuration message comprising information related to the UE;
transmitting, to the base station, a response message indicating a configuration status of the relay; and
transmitting, to the UE, a notification of a status of a relay-to-base-station part of the second path, the notification including a state of the relay.

Clause 54: A non-transitory computer-readable medium storing instructions that are executable by one or more processors of a user equipment (UE) for adding a second path after a first path between a base station and the UE has been established, to perform a method, the method comprising:
receiving, from the base station, a configuration message indicating an addition of the second path, the configuration message comprising information related to a relay of the second path;
establishing a sidelink communication with the relay; and
transmitting, to the base station, a response message indicating a status of configuration of the first path with the addition of the second path based on the configuration message.

Clause 55: A non-transitory computer-readable medium storing instructions that are executable by one or more processors of a base station for adding a second path after a first path between the base station and a user equipment (UE) has been established, to perform a method, the method comprising:
triggering a relay of the second path into a state for connecting with the base station;
transmitting, to the relay, a first configuration message indicating an addition of the second path, the first configuration message comprising information related to the UE;
receiving, from the relay, a first response message indicating a configuration of a relay-to-base-station part of the second path established based on the first configuration message;
receiving, from the relay, a notification indicating an establishment of a sidelink communication between the relay and the UE, the notification including a state of the UE;
transmitting, to the UE, a second configuration message indicating the addition of the second path; and
receiving, from the UE, a second response message indicating a status of configuration of the first path with the addition of the second path based on the second configuration message.

Clause 56: A non-transitory computer-readable medium storing instructions that are executable by one or more processors of a relay for adding a second path after a first path between a base station and a user equipment (UE) has been established, to perform a method, the method comprising:
receiving, from the base station, a trigger for triggering the relay to enter a radio resource control (RRC) connected state;
receiving, from the base station, a configuration message indicating an addition of the second path, the configuration message comprising information related to the UE; and
transmitting, to the base station, a message indicating a configuration of a UE-to-relay part of the second path established based on the configuration message.

Clause 57: A non-transitory computer-readable medium storing instructions that are executable by one or more processors of a user equipment (UE) for adding a second path after a first path between a base station and the UE has been established, to perform a method, the method comprising:
establishing a sidelink communication with a relay included in a network, the network comprising the base station;
receiving, from the network, a configuration message indicating an addition of the second path; and
transmitting, to the network, a response message indicating a status of configuration of the first path with the addition of the second path based on the configuration message.

1. A method for adding a second path after a first path between a base station and a user equipment (UE) has been established, the method comprising:
transmitting, by the base station, to the UE, a first configuration message indicating an addition of the second path, the first configuration message comprising information related to a relay of the second path;
transmitting, by the base station, to the relay, a second configuration message, the second configuration message comprising information related to the UE;
receiving, by the base station, from the relay, a first response message indicating a configuration of a relay-to-base-station part of the second path established based on the second configuration message; and
receiving, by the base station, from the UE, a second response message indicating a status of configuration of the first path with the addition of the second path based on the first configuration message, the second response message including a state of the UE.

2. The method of claim 1, wherein the first path is a direct path between the UE and the base station, and the second path is an indirect path between the UE and the base station via the relay.

3. The method of claim 1, wherein the relay comprises at least one of:
one or more UEs that are different from the UE, or one or more road side units.

4. The method of claim 1, wherein the first configuration message comprises a radio resource control (RRC) reconfiguration message.

5. The method of claim 4, wherein the first configuration message comprises a PC5 initiator.

6. The method of claim 1, wherein the second configuration message comprises an RRC reconfiguration message.

7. The method of claim 1, wherein the information related to the relay included in the first configuration message transmitted to the UE is used by the UE for establishing a sidelink communication between the UE and the relay.

8. The method of claim 1, wherein the first response message received from the relay comprises a status of a UE-to-relay part of the second path.

9. The method of claim 1, wherein before transmitting the second configuration message to the relay, the method further comprises:
triggering, by the base station, the relay to enter an RRC connected state.

10. A method for adding a second path after a first path between a base station and a user equipment (UE) has been established, the method comprising:
receiving, by a relay, from the base station, a configuration message indicating an addition of the second path, the configuration message comprising information related to the UE;
transmitting, by the relay, to the base station, a response message indicating a configuration status of a relay; and
transmitting, by the relay, to the UE, a notification of a status of a relay-to-base-station part of the second path, the notification including a state of the relay.

11. The method of claim 10, wherein the first path is a direct path between the UE and the base station, and the second path is an indirect path between the UE and the base station via the relay.

12. The method of claim 10, wherein the relay comprises at least one of: one or more UEs that are different from the UE, or one or more road side units.

13. The method of claim 10, wherein the configuration message comprises a radio resource control (RRC) reconfiguration message.

14. The method of claim 10, wherein the response message transmitted to the base station comprises a status of configuration of a UE-to-relay part of the second path.

15. A method for adding a second path after a first path between a user equipment (UE) and a base station has been established, the method comprising:
receiving, by the UE, from the base station, a configuration message indicating an addition of the second path, the configuration message comprising information related to a relay of the second path;
establishing, by the UE, a sidelink communication with the relay; and
transmitting, by the UE, to the base station, a response message indicating a status of configuration of the first path with the addition of the second path based on the configuration message.

16. The method of claim 15, wherein the configuration message comprises a radio resource control (RRC) reconfiguration message.

17. The method of claim 15, wherein the configuration message comprises a PC5 initiator for establishing the sidelink communication.

18. The method of claim 15, wherein the method further comprises:
triggering, by the UE, the relay to enter a radio resource control (RRC) connected state after establishment of the sidelink communication.

19. The method of claim 15, wherein the method further comprises:
receiving, by the UE, from the relay, a notification indicating a status of a relay-to-base-station part of the second path, the notification including a state of the relay.

20. The method of claim 15, wherein the response message transmitted to the base station comprises a state of the UE.
